(19) United States
(12) Patent Application Publication
(10) Pub. No.: US 2017/0163953 A1
(43) Pub. Date: Jun. 8, 2017

(54) METHOD AND ELECTRONIC DEVICE FOR PROCESSING IMAGE CONTAINING HUMAN FACE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Wenping Wang, Beijing (CN); Peng Xiao, Beijing (CN)

(21) Appl. No.: 15/243,447

(22) Filed: Aug. 22, 2016

Related U.S. Application Data
(63) Continuation of application No. PCT/CN2016/088995, filed on Jul. 6, 2016.

(30) Foreign Application Priority Data
Dec. 8, 2015 (CN) 201510896549.8

(51) Int. Cl. H04N 9/73; H04N 5/235; H04N 5/232

(52) U.S. Cl. CPC H04N 9/735; H04N 5/23219; H04N 5/2351

(57) ABSTRACT

A method for processing an image containing a human face, including: acquiring an image containing a human face in a current shooting scene; performing human face identification on the image containing a human face to obtain a human face region and an ambient light region other than the human face region; determining a human face decision point in the human face region and an ambient light decision point in the ambient light region; adjusting a white balance parameter according to the human face decision point, the ambient light decision point and a predetermined distance threshold; and adjusting the image containing a human face according to the white balance parameter.

### CROSS-REFERENCE TO RELATED APPLICATIONS

The present application is a continuation application of a PCT application No. PCT/CN2016/088995, filed on Jul. 6, 2016, which claims the priority of Chinese patent application No. 201510896549.8 filed on Dec. 8, 2015, titled “METHOD AND DEVICE FOR PROCESSING IMAGE CONTAINING HUMAN FACE”, the entire content of both applications is incorporated herein by reference.

### TECHNICAL FIELD

The present application relates to the field of image processing technologies, and in particular, to a method and an electronic device for processing an image containing a human face.

### BACKGROUND

In the prior art, the white balance of an intelligent terminal in different scenes is obtained by determining the locations of gray points on the whole picture. When a front camera of an intelligent terminal is employed to take a “selfie”, the human face region in the selfie image occupies a large proportion. The human face region in the image has a warm color, and the pixel points in this region fall into the warm color region. The pixel points of the human face region occupy a large proportion of the pixel points on the whole image, and the white balance is misjudged as a color temperature, and finally it causes the overall image to be blue after white balance processing.

Additionally, most of the people like to take a scene in an environment with brilliant colors, and the background of an image shot by a rear camera has a high saturation, and the human face region is caused to be red after white balance debugging. In the prior art, when a red human face region in an image is processed, the red degree of the human face region is generally adjusted by decreasing the saturation of the whole image.

Thus, it may be seen that in the prior art, when an image containing a human face is processed, white balance debugging cannot be well performed, and hence the image quality will be poor.

### SUMMARY

The application provides a method and an electronic device for processing an image containing a human face, thereby effectively restoring the nature of a scene, and improving the image quality.

In one aspect, embodiments of the present application provide a method for processing an image containing a human face, which includes:

acquiring an image containing a human face in a current shooting scene;

performing human face identification on the image containing a human face, to obtain a human face region and an ambient light region other than the human face region;

determining a human face decision point in the human face region and an ambient light decision point in the ambient light region;

adjusting a white balance parameter according to the human face decision point, the ambient light decision point and a predetermined distance threshold; and

adjusting the image containing a human face according to the white balance parameter.

In another aspect, embodiments of the present application further provide an electronic device for processing an image containing a human face, which includes:

at least one processor; and

a memory communicably connected with the at least one processor for storing instructions executable by the at least one processor, wherein execution of the instructions by the at least one processor causes the at least one processor to:

acquire an image containing a human face in a current shooting scene;

perform human face identification on the image containing a human face to obtain a human face region and an ambient light region other than the human face region;

determine a human face decision point in the human face region and an ambient light decision point in the ambient light region;

adjust a white balance parameter according to the human face decision point, the ambient light decision point and a predetermined distance threshold; and

adjust the image containing a human face according to the white balance parameter.

In a third aspect, embodiments of the present application further provide a non-transitory computer-readable storage medium storing computer executable instructions that, when executed by an electronic device, cause the electronic device to:

acquire an image containing a human face in a current shooting scene;

perform human face identification on the image containing a human face to obtain a human face region and an ambient light region other than the human face region;

determine a human face decision point in the human face region and an ambient light decision point in the ambient light region;

adjust a white balance parameter according to the human face decision point, the ambient light decision point and a predetermined distance threshold; and

adjust the image containing a human face according to the white balance parameter.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for processing an image containing a human face according to Embodiment 1 of the disclosure;

FIG. 2 is a flow chart of a method for processing an image containing a human face according to Embodiment 2 of the disclosure;

FIG. 3 is a flow chart of a method for processing an image containing a human face according to Embodiment 3 of the disclosure;

FIG. 4 is a structural representation of a device for processing an image containing a human face according to Embodiment 4 of the disclosure; and

FIG. 5 is a functional block diagram showing the hardware of an electronic device for processing an image containing a human face according to Embodiment 6 of the disclosure.

### DETAILED DESCRIPTION

The disclosure will be illustrated in detail in conjunction with the drawings and embodiments. It may be understood that, the embodiments described here are only used for explaining the disclosure, rather than limiting the scope of the disclosure. Additionally, it should be noted that, for easy description, the drawings only show the parts related to the disclosure, rather than the whole structure.

### Embodiment 1

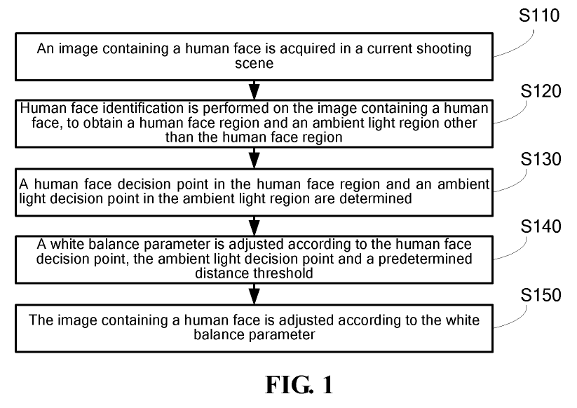

FIG. 1 is a schematic flow chart of a method for processing an image containing a human face according to Embodiment 1 of the disclosure. The method is performed by a device for processing an image containing a human face, which is generally integrated in a device having a photographing function, such as an intelligent mobile terminal. Referring to FIG. 1, the method for processing an image containing a human face includes:

S110: an image containing a human face is acquired in a current shooting scene;

After a device with a photographing function is turned on, an image containing a human face is taken in the current scene by a front camera or a rear camera in the device. Wherein, the device with a photographing function may be an intelligent mobile phone, a tablet computer and a personal computer with a camera.

S120: human face identification is performed on the image containing a human face, to obtain a human face region and an ambient light region other than the human face region;

The image containing a human face is divided into regions, the human face region may be identified by various human face identification algorithms, and the region other than the human face region in the image is determined as an ambient light region.

Adaboost algorithm can be used as the human face identification algorithms. Adaboost is an iterative algorithm. The core concept of Adaboost algorithm is to train different classifier (weak classifiers) for the same training set, and then to combine these weak classifiers to form a strong final classifier (strong classifier). The algorithm itself is realized by changing data distribution, and it determines the weight value of each sample in each training set according to whether the sample is classified correctly and according to the overall accuracy rate of the last classification, and delivers a new data set with a modified weight value to a lower-level classifier for training, and finally fuses the classifiers obtained in each train as a final decision classifier. Preferably, in the Adaboost algorithm, a dynamic threshold may be employed to accelerate human face identification. The human face identification algorithm may also employ other algorithms that can rapidly identify a human face region, which is not limited in the disclosure.

Optionally, the performing human face identification on the image containing a human face to obtain a human face region and an ambient light region other than the human face region may include: performing human face identification on the image containing a human face, and determining a rectangular frame corresponding to the human face; extracting a human face profile from the rectangular frame; and taking the human face profile as the human face region, and taking other regions in the image as the ambient light region.

Wherein, the extracting a human face profile from the rectangular frame may include extracting a human face profile via an active shape model or an active appearance model.

S130: a human face decision point in the human face region and an ambient light decision point in the ambient light region are determined.

First of all, the image containing a human face is divided into regions, and the red/green ratio and blue/green ratio of the pixel points in each part are calculated according to the color of each part of the image. The red/green ratios of all pixel points in each part are averaged, the blue/green ratios of all pixel points in each part are averaged, and the average values are taken as the red/green ratio and the blue/green ratio of the part. In conjunction with an R/G-B/G histogram in which red/green (R/G) is taken as the X-axis and blue/green (B/G) is taken as the Y-axis, the light source of each part in the image is determined according to the red/green ratio and the blue/green ratio of each part in the image and the red/green ratio range and the blue/green ratio range of the light source. A part in the image of which the red/green ratio and the blue/green ratio fall outside the red/green ratio range and the blue/green ratio range of the light source belongs to a gray region. The natural light sources include a light source D75, a light source D65, a light source D50, a light source CW, a light source TL84, a light source A and a light source H, where each of the light sources respectively corresponds to a certain R/G and B/G.

The R/G and B/G average values of a part in the image of which the human face region falls into the gray region are calculated, and the R/G average value and the B/G average value are taken as human face decision points. The ambient light decision points are obtained via the same calculation.

Additionally, the image containing a human face may not be divided into macro blocks; instead, a human face decision point and an ambient light decision point are obtained according to the R, G and B colors of all pixel points in the human face region and the ambient light region. The method of calculating a human face decision point and an ambient light decision point via pixel points is applicable for an image containing a human face that has a small amount of pixel points.

S140: a white balance parameter is adjusted according to the human face decision point, the ambient light decision point and a predetermined distance threshold;

The R/G and B/G values of the human face decision point are mapped to the R/G-B/G histogram, and the human face decision point falls into the R/G and B/G range corresponding to a light source, so that the light source corresponding to the human face decision point is determined; and the light source corresponding to the ambient light decision point is determined via the same method. The white balance parameter may be adjusted by the light sources.

The distance between the human face decision point and the ambient light decision point can represent the distance between the mainstream light source of the human face region and the mainstream light source of the ambient light region. When the distance between the human face decision point and the ambient light decision point is greater than a predetermined distance threshold, it indicates that the distance between the mainstream light source of the human face region and the mainstream light source of the ambient light region is large. Accordingly, the white balance parameter in the human face region is adjusted according to the light source corresponding to the human face decision point, and the white balance parameter in the ambient light region is adjusted according to the light source corresponding to the ambient light decision point.

By comparing the distance between the human face decision point and the ambient light decision point with the predetermined distance threshold, adjustment of the white balance parameter is performed on the human face region and the ambient light region respectively, thus avoiding the drawbacks that the display effect of the ambient light region is lowered due to the adjustment of the human face part or the display effect of the human face region is lowered due to the adjustment of the ambient light region.

Optionally, the adjusting a white balance parameter according to the human face decision point, the ambient light decision point and a predetermined distance threshold may include: calculating a decision point distance between the human face decision point and the ambient light decision point; and adjusting the white balance parameter according to a relation between the decision point distance and a predetermined distance threshold.

S150: the image containing a human face is adjusted according to the white balance parameter.

After the white balance parameter is adjusted, the images of the human face region and the ambient light region may be adjusted according to the white balance parameters in the human face region and in the ambient light region.

In the technical solution according to the embodiment of the disclosure, by dividing an image containing a human face into a human face region and an ambient light region and performing adjustment of the white balance parameter on the human face region, the mutual influence on the human face region and the ambient light region may be avoided, thus restoring the nature of the scene effectively, and improving the image quality.

### Embodiment 2

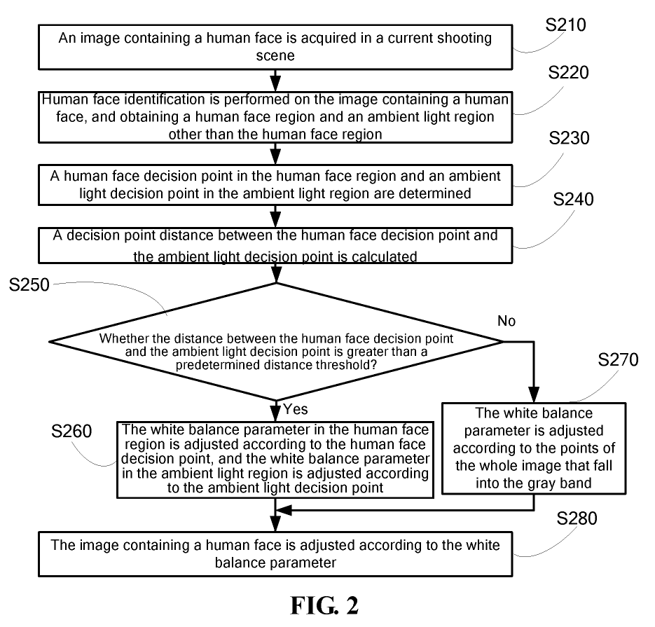

FIG. 2 is a schematic flow chart of a method for processing an image containing a human face according to Embodiment 2 of the disclosure. Referring FIG. 2, the method for processing an image containing a human face includes:

S210: an image containing a human face is acquired in a current shooting scene;

S220: human face identification is performed on the image containing a human face to obtain a human face region and an ambient light region other than the human face region;

S230: a human face decision point in the human face region and an ambient light decision point in the ambient light region are determined;

S240: a decision point distance between the human face decision point and the ambient light decision point is calculated;

S250: whether the distance between the human face decision point and the ambient light decision point is greater than a predetermined distance threshold, if yes, turning to step S260 is determined; otherwise, turning to step S270.

S260: the white balance parameter in the human face region is adjusted according to the human face decision point, and the white balance parameter in the ambient light region is adjusted according to the ambient light decision point, and then turning to step S280;

When the distance between the human face decision point and the ambient light decision point is greater than a predetermined distance threshold, the human face region adjusts the white balance parameter in the human face region according to the human face decision point, and the ambient light region adjusts the white balance parameter in the ambient light region according to the ambient light decision point.

S270: the white balance parameter is adjusted according to the points of the whole image that fall into the gray band;

Because the human face region generally has a warm light source, i.e., A light source, when the distance between the human face decision point and the ambient light decision point is less than the predetermined distance threshold, the mainstream light source of the ambient light region may be A light or H light, or may have TL85 light source in a small part thereof, so that the light source of the ambient light region and the light source of the human face region are both warm color lights; In this case, the global decision point is recalculated according to the part of the whole image containing a human face that falls into the gray region, and the white balance parameter of the whole image containing a human face is adjusted by the global decision point.

S280: the image containing a human face is adjusted according to the white balance parameter.

In the technical solution according to the embodiment of the disclosure, by dividing an image containing a human face into a human face region and an ambient light region and performing adjustment of the white balance parameter on the human face region, the mutual influence on the human face region and the ambient light region may be avoided, thus restoring the nature of the scene effectively, and improving the image quality.

### Embodiment 3

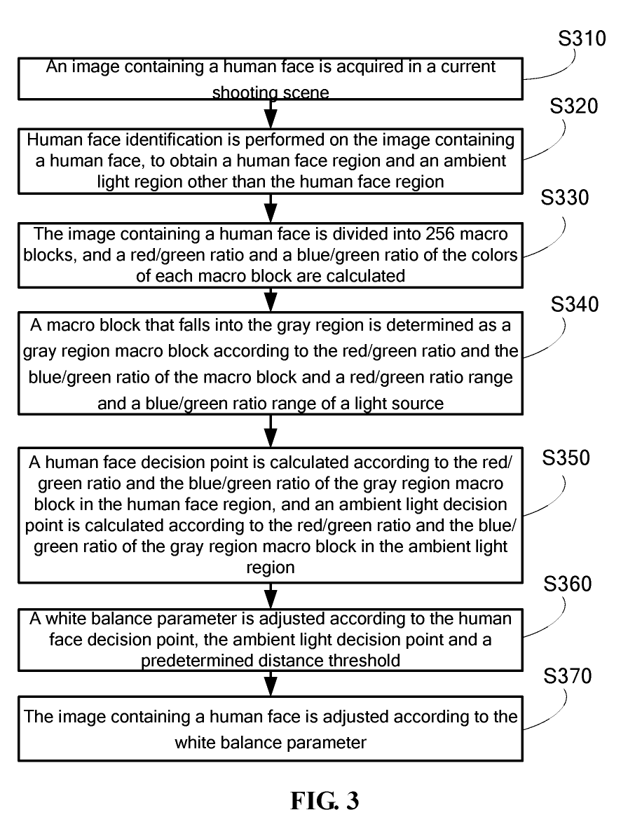

FIG. 3 is a schematic flow chart of a method for processing an image containing a human face according to Embodiment 3 of the disclosure. Referring FIG. 3, the method for processing an image containing a human face includes:

S310: an image containing a human face is acquired in a current shooting scene;

S320: Human face identification is performed on the image containing a human face, to obtain a human face region and an ambient light region other than the human face region;

S330: the image containing a human face is divided into 256 macro blocks, and a red/green ratio and a blue/green ratio of the color of each macro block are calculated;

Where, the image containing a human face is divided into 16 rows and 16 columns, i.e., 256 macro blocks, each of the macro blocks corresponds to a subimage in a certain image, and the number of the macro blocks may be set as desired. The R/G and B/G average values of the pixel points contained in a macro block may be taken as the R/G and B/G of the macro block.

S340: a macro block that falls into the gray region is determined as a gray region macro block according to the red/green ratio and the blue/green ratio of the macro block and a red/green ratio range and a blue/green ratio range of a light source;

S350: a human face decision point is calculated according to the red/green ratio and the blue/green ratio of the gray region macro block in the human face region, and an ambient light decision point is calculated according to the red/green ratio and the blue/green ratio of the gray region macro block in the ambient light region;

Exemplarily, the R/G and B/G average values or weighted average values of the gray region macro blocks in the human face region are calculated respectively, and the corresponding R/G and B/G average values or weighted average values are taken as the R/G and B/G of the human face decision point.

S360: a white balance parameter is adjusted according to the human face decision point, the ambient light decision point and a predetermined distance threshold;

The R/G and B/G values of the human face decision point are mapped to the R/G-B/G histogram, and the human face decision point falls into the R/G and B/G range corresponding to a light source, so that the light source corresponding to the human face decision point is determined; and the light source corresponding to the ambient light decision point is determined via the same method. The white balance parameter may be adjusted by the light source.

The distance between the light source of the human face region and the light source of the ambient light region may be obtained according to the relation between the human face decision point, the ambient light decision point and a predetermined distance threshold. Adjustment of the white balance parameter may be performed on the human face region and the ambient light region respectively by the determination of the distance between light sources, or adjustment of the white balance parameter may be performed on the whole image containing a human face by employing one decision point.

S370: the image containing a human face is adjusted according to the white balance parameter.

In the technical solution according to the embodiment of the disclosure, by dividing an image containing a human face into a human face region and an ambient light region and performing adjustment of the white balance parameter on the human face region, the mutual influence on the human face region and the ambient light region may be avoided, thus restoring the nature of a scene effectively, and improving the image quality.

### Embodiment 4

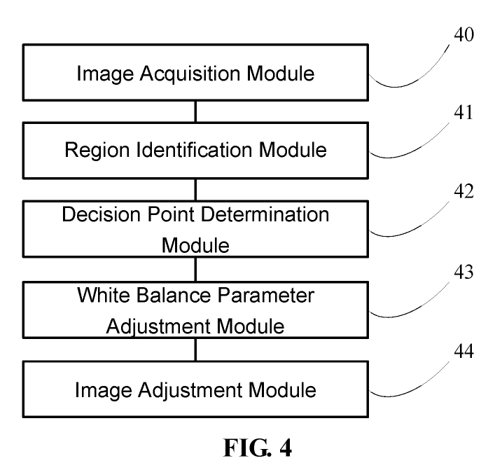

FIG. 4 is a structural representation of a device for processing an image containing a human face according to Embodiment 4 of the disclosure. Referring FIG. 4, the device for processing an image containing a human face includes: an image acquisition module 40, a region identification module 41, a decision point determination module 42, a white balance parameter adjustment module 43 and an image adjustment module 44.

Where, the image acquisition module 40 is configured for acquiring an image containing a human face in a current shooting scene; the region identification module 41 is configured for performing human face identification on the image containing a human face to obtain a human face region and an ambient light region other than the human face region; the decision point determination module 42 is configured for determining a human face decision point in the human face region and an ambient light decision point in the ambient light region; the white balance parameter adjustment module 43 is configured for adjusting a white balance parameter according to the human face decision point, the ambient light decision point and a predetermined distance threshold; and the image adjustment module 44 is configured for adjusting the image containing a human face according to the white balance parameter.

Optionally, the white balance parameter adjustment module 43 includes: a decision point distance calculation unit and a white balance parameter adjustment unit.

Where, the decision point distance calculation unit is configured for calculating a decision point distance between the human face decision point and the ambient light decision point; and the white balance parameter adjustment unit is configured for adjusting the white balance parameter according to a relation between the decision point distance and a predetermined distance threshold.

Optionally, the white balance parameter adjustment unit is further configured for:

adjusting the white balance parameter in the human face region according to the human face decision point and adjusting the white balance parameter in the ambient light region according to the ambient light decision point, when the distance between the human face decision point and the ambient light decision point is greater than the predetermined distance threshold; and

adjusting the white balance parameter according to the points of the whole image that fall into the gray band, when the distance between the human face decision point and the ambient light decision point is less than the predetermined distance threshold.

Optionally, the region identification module 41 includes: a human face rectangular frame determination unit, a human face profile extraction unit and a region division unit.

Where, the human face rectangular frame determination unit is configured for performing human face identification on the image containing a human face, to determine a rectangular frame corresponding to the human face; the human face profile extraction unit is configured for extracting a human face profile from the rectangular frame; the region division unit is configured for taking the human face profile as a human face region, and taking other regions in the image as the ambient light region.

Optionally, the decision point determination module 42 includes: a color ratio calculation unit, a gray region macro block determination unit and a decision point calculation unit.

Where, the color ratio calculation unit is configured for dividing the image containing a human face into 256 macro blocks, and calculating a red/green ratio and a blue/green ratio of the colors of each of the macro blocks; the gray region macro block determination unit is configured for determining a macro block that falls into the gray region as a gray region macro block according to the red/green ratio and the blue/green ratio of the macro block and a red/green ratio range and a blue/green ratio range of a light source; the decision point calculation unit is configured for calculating a human face decision point according to the red/green ratio and the blue/green ratio of the gray region macro block in the human face region, and calculating an ambient light decision point according to the red/green ratio and the blue/green ratio of the gray region macro block in the ambient light region.

In the technical solution according to the embodiment of the disclosure, by dividing an image containing a human face into a human face region and an ambient light region and performing adjustment of the white balance parameter on the human face region, the nature of a scene may be effectively restored, thus improving the image quality.

### Embodiment 5

One embodiment of the disclosure provides a nonvolatile computer storage medium, in which a computer-executable instruction is stored, wherein the computer-executable instruction is configured for executing the method for processing an image containing a human face according to any of the above method embodiments.

### Embodiment 6

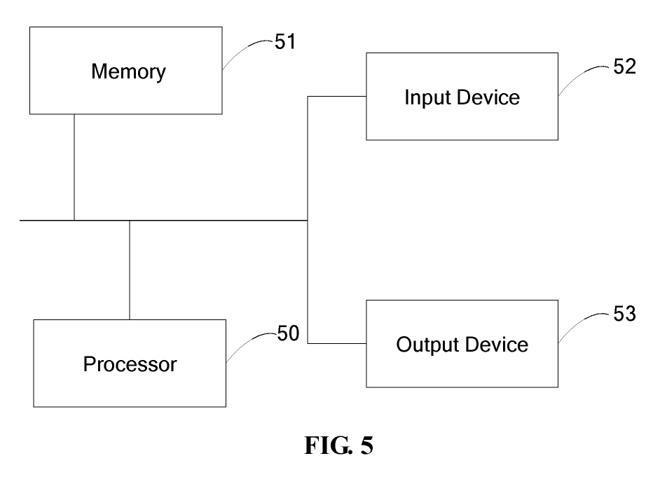

FIG. 5 is a structural representation showing the hardware of an electronic device for processing an image containing a human face according to Embodiment 6 of the disclosure. Referring FIG. 5, the electronic device includes:

one or more processors 50 and a memory 51; FIG. 5 shows an example in which the device includes one processor 50.

The device may further include: an input device 52 and an output device 53. The processor 50, the memory 51, the input device 52 and the output device 53 in the device may be connected via a bus or in other manners. FIG. 5 shows an example in which they are connected via a bus.

As a non-transitory computer-readable storage medium, the memory 51 may be configured for storing a nonvolatile software program, a nonvolatile computer-executable program and a module, such as the program instruction/module corresponding to the method for processing an image containing a human face in the embodiments of the disclosure (for example, the image acquisition module 40, the region identification module 41, the decision point determination module 42, the white balance parameter adjustment module 43 and the image adjustment module 44 shown in FIG. 4). The processor 50 executes the functional application and data processing of a server by running the software programs, instructions and modules stored in the memory 51, thereby implementing the method for processing an image containing a human face according to the above method embodiments.

The memory 51 may include a program storage region and a data storage region, where, the program storage region may be configured for storing an operating system and at least one functional application program; and the data storage region may be configured for storing the data created according to the use of a terminal device, etc. Additionally, the memory 51 may include a high random access memory, or it may further include a nonvolatile memory, for example, at least one disk storage apparatus, flash memory apparatus or other nonvolatile solid-state memory apparatuses. In some examples, the memory 51 may include a memory set remotely relative to the processor 50, and such a remote memory may be connected to a terminal device via a network. An example of the above network includes, but is not limited to, Internet, Intranet, Local Area Network (LAN), Mobile Communication Network and a combination thereof.

The input device 52 may be configured for receiving the inputted digit or character information and generating a key signal input related to the user setting and function control of the terminal. The output device 53 may include a display device, such as a display screen.

The one or more modules are stored in the memory 51. When executed by the one or more processors 50, the one or more modules will perform the steps of the method for processing an image containing a human face according to any of the above method embodiments.

The above product may perform the method according to the embodiments of the disclosure, and it may have the corresponding functional modules and beneficial effects of the method performed. For the technical details that are not described fully in this embodiment, reference may be made to the method provided in the embodiments of the disclosure.

The electronic equipment in embodiments of this application exists in various forms, including but not limited to:

(1) mobile telecommunication device. A device of this kind has a feature of mobile communicating function, and has a main object of providing voice and data communication. Devices of this kind include smart phone (such as iPhone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement do not make essential of corresponding technical solutions depart from spirits and scope of technical solutions of various embodiments.

What is claimed is:

1. A method for processing an image containing a human face, comprising:
at an electronic device,
acquiring an image containing a human face in a current shooting scene;
performing human face identification on the image containing a human face, to obtain a human face region and an ambient light region other than the human face region;
determining a human face decision point in the human face region and an ambient light decision point in the ambient light region;
adjusting a white balance parameter according to the human face decision point, the ambient light decision point and a predetermined distance threshold; and
adjusting the image containing a human face according to the white balance parameter.

2. The method according to claim 1, wherein, the adjusting a white balance parameter according to the human face decision point, the ambient light decision point and a predetermined distance threshold comprises:
calculating a decision point distance between the human face decision point and the ambient light decision point; and
adjusting the white balance parameter according to a relation between the decision point distance and the predetermined distance threshold.

3. The method according to claim 2, wherein, the adjusting the white balance parameter according to a relation between the decision point distance and the predetermined distance threshold comprises:
adjusting the white balance parameter in the human face region according to the human face decision point and adjusting the white balance parameter in the ambient light region according to the ambient light decision point, when the distance between the human face decision point and the ambient light decision point is greater than the predetermined distance threshold; and
adjusting the white balance parameter according to the points of the whole image that fall into a gray band, when the distance between the human face decision point and the ambient light decision point is less than the predetermined distance threshold.

4. The method according to claim 1, wherein, the performing human face identification on the image containing a human face to obtain a human face region and an ambient light region other than the human face region comprises:
performing human face identification on the image containing a human face, to determine a rectangular frame corresponding to the human face;
extracting a human face profile from the rectangular frame; and
taking the human face profile as the human face region, and taking other regions in the image as the ambient light region.

5. The method according to claim 1, wherein, the determining a human face decision point in the human face region and an ambient light decision point in the ambient light region comprises:
dividing the image containing a human face into 256 macro blocks, and calculating a red/green ratio and a blue/green ratio of the color of each macro block;
determining a macro block that falls into the gray region as a gray region macro block according to the red/green ratio and the blue/green ratio of the macro block and a red/green ratio range and a blue/green ratio range of a light source; and
calculating a human face decision point according to the red/green ratio and the blue/green ratio of the gray region macro block in the human face region, and calculating an ambient light decision point according to the red/green ratio and the blue/green ratio of the gray region macro block in the ambient light region.

6. An electronic device for processing an image containing a human face, comprising:
at least one processor; and
a memory communicably connected with the at least one processor for storing instructions executable by the at least one processor, wherein execution of the instructions by the at least one processor causes the at least one processor to:
acquire an image containing a human face in a current shooting scene,
perform human face identification on the image containing a human face to obtain a human face region and an ambient light region other than the human face region,
determine a human face decision point in the human face region and an ambient light decision point in the ambient light region,
adjust a white balance parameter according to the human face decision point, the ambient light decision point and a predetermined distance threshold, and
adjust the image containing a human face according to the white balance parameter.

7. The electronic device according to claim 6, wherein, the execution of the instructions by the at least one processor further causes the at least one processor to:
calculate a decision point distance between the human face decision point and the ambient light decision point; and
adjust the white balance parameter according to a relation between the decision point distance and the predetermined distance threshold.

8. The device according to claim 7, wherein, the execution of the instructions by the at least one processor further causes the at least one processor to:
adjust the white balance parameter in the human face region according to the human face decision point and adjust the white balance parameter in the ambient light region according to the ambient light decision point, when the distance between the human face decision point and the ambient light decision point is greater than the predetermined distance threshold; and
adjust the white balance parameter according to the points of the whole image that fall into the gray band, when the distance between the human face decision point and the ambient light decision point is less than the predetermined distance threshold.

9. The device according to claim 6, wherein, the execution of the instructions by the at least one processor further causes the at least one processor to:
perform human face identification on the image containing a human face to determine a rectangular frame corresponding to the human face;
extract a human face profile from the rectangular frame; and
take the human face profile as the human face region and take other regions in the image as the ambient light region.

10. The device according to claim 6, wherein, the execution of the instructions by the at least one processor further causes the at least one processor to:
divide the image containing a human face into 256 macro blocks, and calculate a red/green ratio and a blue/green ratio of the color of each macro block;
determine a macro block that falls into the gray region as a gray region macro block according to the red/green ratio and the blue/green ratio of the macro block and a red/green ratio range and a blue/green ratio range of a light source; and
calculate a human face decision point according to the red/green ratio and the blue/green ratio of the gray region macro block in the human face region, and calculate an ambient light decision point according to the red/green ratio and the blue/green ratio of the gray region macro block in the ambient light region.

11. A non-transitory computer-readable storage medium storing executable instructions that, when executed by an electronic device, cause the electronic device to:
acquire an image containing a human face in a current shooting scene;
perform human face identification on the image containing a human face to obtain a human face region and an ambient light region other than the human face region;
determine a human face decision point in the human face region and an ambient light decision point in the ambient light region;
adjust a white balance parameter according to the human face decision point, the ambient light decision point and a predetermined distance threshold; and
adjust the image containing a human face according to the white balance parameter.
